(19) United States
(12) Patent Application Publication
(10) Pub. No.: US 2009/0113317 A1
(43) Pub. Date: Apr. 30, 2009

(54) System and Method for Website Design

(76) Inventors: Vannie Coleman Summers, Sherman Oaks, CA (US); Joshua Summers, Sherman Oaks, CA (US)

Correspondence Address: BOOTH UDALL, PLC, 1155 W. Rio Salado Pkwy., Suite 101, Tempe, AZ, 85281, US

(21) Appl. No.: 12/262,748

(22) Filed: Oct. 31, 2008

Related U.S. Application Data
(60) Provisional application No. 60/984,031, filed on Oct. 31, 2007.

(51) Int. Cl. G06F 17/30; G06F 3/048

(52) U.S. Cl. 715/760; 707/10; 707/E17.032

(57) ABSTRACT

A system and method is disclosed for website design. The system includes a client side interface configured to configure one or more modules and one or more websites comprising one or more web pages. The one or more websites are in communication with the client side interface and are configured to receive real time module configuration information from the client side interface and render a visual representation of the module configuration information.

### CROSS-REFERENCE TO RELATED APPLICATIONS

The present invention is related to that disclosed in U.S. Provisional Patent Application Ser. No. 60/984,031, filed 31 Oct. 2007, entitled “SYSTEM AND METHOD FOR WEBSITE DESIGN” to Joshua Summers, et. al. The subject matter disclosed in U.S. Provisional Patent Application Ser. No. 60/984,031 is hereby incorporated by reference into the present disclosure as if fully set forth herein. The present invention hereby claims priority under 35 U.S.C. §119(e) to U.S. Provisional Patent Application Ser. No. 60/984,031.

### TECHNICAL FIELD OF THE INVENTION

This invention relates generally to website design, and more particularly to systems and methods for creating custom websites.

### BACKGROUND OF THE INVENTION

The World Wide Web has become an important communications medium for wide-ranging purposes, from personal information gathering and exchange to commercial transactions. As personal devices such as computers, personal digital assistants (PDA's), cellular telephones, etc. are becoming increasingly integrated with this medium, individuals are becoming more reliant on the content and services offered. To take advantage of the World Wide Web, it may be necessary for businesses and individual users to design and maintain a web site that other users can visit, and which may permit the desired interaction with other users.

The procedure for designing a web site has historically taken one of two paths. First, it is possible for a business or individual to use a software package that assists in generating such a web site. However, the look and feel of the resulting web site may typically be similar to all other websites generated with the same software package because the number of choices of design or “templates” may be limited. Additionally, the skills required to successfully operate web site development software packages may beyond the skills possessed by businesses and/or individuals. Moreover, web sites created with software packages may not have the level of complexity required by many businesses and individuals.

In order to overcome these and other drawbacks, those desiring a web site may hire an outside firm to custom build its website. While custom-built websites may solve the problems of lack of uniqueness and professionalism frequently encountered with web site development software packages, the use of custom-built websites may present other drawbacks. Typically, custom-built websites may be labor intensive and, consequently, may be expensive to create and maintain. Specifically, custom-built websites may typically cost from a few hundred dollars to a few hundred thousand dollars or more, and may take months to complete due to their labor-intensiveness. Additionally, custom-built websites may experience problems with usability. In particular, sophisticated graphically-intensive custom-websites may require extensive labor to maintain and to administer changes. In particular, once the design of a web site is completed and the site is up and running on the World Wide Web, the maintenance costs for maintaining and updating the site may be substantial. Also, any additions to the site, such as adding new pages or new sections, may be very expensive. Furthermore, such added pages may not fit within the overall scheme of the existing website, thereby resulting in an unwieldy site. An additional problem with custom-built websites may be that websites may become dated in appearance or content, and may therefore require expensive changes or a new custom website altogether.

### SUMMARY OF THE INVENTION

A system for website design is disclosed. The system includes a client side interface operable to configure one or more modules and one or more websites comprising one or more web pages. The one or more websites are in communication with the client side interface and are operable to receive real-time module configuration information from the client side interface and render a visual representation of the module configuration information.

Particular embodiments of a system for website design may include one or more of the following. The client side interface may comprise one or more checkout options. The module configuration information may be received in a database operable to receive and store module configuration information. The module configuration information may be received in the database when a user selects one of the one or more checkout options. The module configuration information may be received in the database via a server side language gateway, and the server side language gateway may be operable to receive the module configuration information from the first client side interface, translate the module configuration information, and output the translated module configuration information to the one or more websites. The translated module configuration information may comprise a text based serialization language. The one or more websites may be further operable to receive the translated module configuration information from the server side language gateway, configure the translated module configuration information to fit one or more website parameters, and render a visual representation of the translated module configuration information.

A computer-implemented method for website design is also disclosed. The method provides for configuring one or more modules, receiving module configuration information at one or more websites in real time and selecting one or more checkout options. The method further provides for communicating module configuration information to a database, receiving module configuration information in the database, translating the module configuration information via a server side language gateway, and outputting translated module configuration information to one or more websites. The method yet further provides for receiving the translated module configuration information at the one or more websites, configuring the translated module configuration information to fit one or more website parameters, and rendering a visual representation of the translated module configuration information.

Particular embodiments of a method for website design may include one or more of the following. Configuring one or more modules may comprise selecting one or more templates. Configuring one or more modules may comprise creating a page map with one or more associated web pages. Configuring one or more modules may comprise assigning one or more modules for at least one of the one or more associated web pages. Configuring one or more modules may comprise uploading custom content. Uploading custom content may occur after selecting one or more checkout options. Custom content may comprise one or more of text content, audio content, video content, software content, pictorial content, stylized content, and photographic content.

Software for website design is further disclosed. The software is operable to configure one or more modules via a client side interface, store module configuration information in the client side interface, and update one or more websites in communication with the client side interface with the module configuration information, the update occurring in real time.

Particular embodiments of software for website design may include one or more of the following. The software may be further operable to configure a database to receive the module configuration information from the client side interface when a user selects at least one of the one or more checkout options. The software may be further operable to provide one or more module configuration options based at least upon a user selection of at least one of the one or more checkout options. The software may be further operable to configure the client side interface to provide a payment screen when a user selects one of the one or more checkout options. The software may be further operable to configure a server side language gateway to receive the module configuration information from the first client side interface, translate the module configuration information, and output the translated module configuration information from the server side language gateway to the one or more websites. In addition, the software may be further operable to configure the one or more websites to receive the translated module configuration information from the server side language gateway, configure the translated module configuration information to fit one or more website parameters, and render a visual representation of the translated module configuration information.

### BRIEF DESCRIPTION OF THE DRAWINGS

The novel features believed characteristic of a system and method for website design are set forth in the appended claims. Nevertheless, the system and method for website design themselves, as well as a preferred mode of use, and further objectives and advantages thereof, will best be understood by reference to the following detailed description when read in conjunction with the accompanying drawings, wherein:

FIG. 1 illustrates a first particular embodiment of an exemplary website design system;

FIG. 2 illustrates a second particular embodiment of an exemplary website design system;

FIG. 3 illustrates a particular embodiment of a content management system; and

FIG. 4 illustrates an exemplary method for website design.

### DETAILED DESCRIPTION OF THE INVENTION

Reference will now be made to the following detailed description of the preferred and alternate embodiments. Those skilled in the art will recognize that the present invention provides many inventive concepts and novel features, that are merely illustrative, and are not to be construed as restrictive. Accordingly, the specific embodiments discussed herein are given by way of example and do not limit the scope of the present invention.

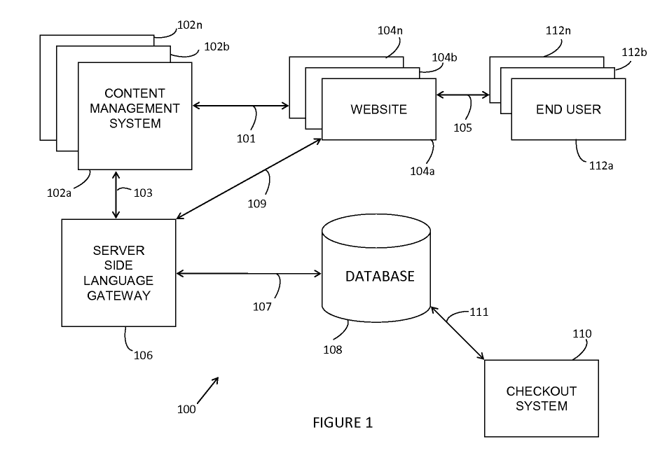

FIGS. 1-3 illustrate various aspects and embodiments of an exemplary website design system 100. Website design system 100 comprises one or more content management systems 102a-102n, one or more websites 104a-104n, server side language gateway 106, database 108, cart 110, one or more end users 112a-112n, and communication links 101, 103, 105, 107, 109, and 111 (which may be any wireline, wireless, or other link suitable to support data communications between the various system components). Although a single one or more content management systems 102-102n, one or more websites 104a-104n, server side language gateway 106, database 108, cart 110, and one or more end users 112a-112n are shown and described, embodiments contemplate any number of one or more content management systems 102a-102n, any number of one or more websites 104a-104n, any number of server side language gateways 106, any number of databases 108, any number of carts 110, and/or any number of end users 112a-112n, according to particular needs. In addition, or as an alternative, website design system 100 may be integral to or separate from the hardware and/or software of any one of the content management systems 102, websites 104a-104n, and/or database 108.

In particular embodiments, one or more content management systems 102a-102n may comprise one or a variety of user client side interfaces. Specifically, one or more content management systems 102a-102n may comprise one or more graphical elements representing one or more modules including, by way of non-limiting example, module 300; template 302; flow-chart 304; web page lists 306; module configuration option 308; module assignment option 310; custom content option 312; upload option 314; welcome message 316; purchase option 318; payment option 320; data option 322; web page management option 324; web page updating option 326, miscellaneous option 328, user sale module 330 and/or any other appropriate module. In particular embodiments, one or more website configuration files associated with one or more websites 104a-104n may be operable to determine which particular module or modules are presented for modification to one or more content management systems 102a-102n by one or more websites 104a-104n. In those particular embodiments where one or more website configuration files are associated with one or more websites 104a-104n, the one or more website configuration files may be modified by one or more users.

In some particular embodiments, one or more modules may be associated with one or more websites 104a-104n. In other particular embodiments, one or more modules may be located externally with respect to one or more websites 104a-104n (such as, by way of non-limiting example, at one or more content management systems 102a-102n). Module 300 (or any other module set forth above) may comprise any component or sub-assembly relating to the content and/or design of one or more websites 104a-104n, and may be configured (described below) via one or more content management systems 102a-102n. By way of non-limiting example, module 300 may comprise a complete Flash® module, which may represent a self-contained component for one or more websites 102a-102n. One or more modules 300 may contain all the design and content information and implementing components required for a website. In addition, template 302 may comprise any pre-developed page layout (or even audio or sound file template) used to create new pages from the same design, pattern, or style. Therefore, in particular embodiments, one or more users may even create one or more custom sound loops using one or more templates 302. In addition to the foregoing, a user may configure one or more user sale modules 330 to include content and design relating to products sold by that particular user. Therefore, via one or more content management systems 102a-102n, a user may create listings of goods and/or services that may be offered to other users, such as via one or more content management systems 102a-102n, checkout system 110, or in any other appropriate manner consistent with the disclosures contained herein. It will be understood that a virtually limitless number of module 300, template 302, user sale module 330 and/or other module possibilities, styles and configurations may be provided in accordance with particular needs,which may vary according to individual, industry, and/or other reasons.

Although, one or more content management systems 102a-102n are shown and described as having one or more graphical elements including a visual representation of a plurality of modules, embodiments contemplate any suitable number of graphical elements associated with any number of modules, according to particular needs.

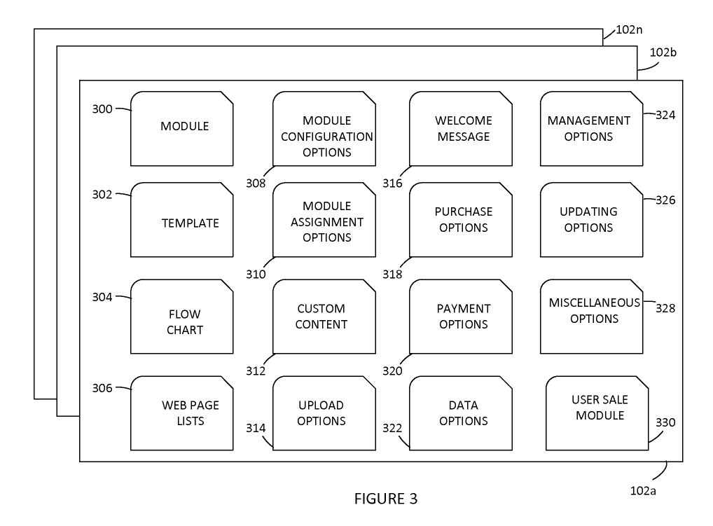

To further explain the operation of one or more content management systems 102a-102n, a non-limiting example is now given. In one particular embodiment, content management system 102a comprises welcome message 316. After navigating through welcome message 316 (FIG. 3), a user may select (via one or more appropriate graphical elements) various modules relating to the specific layout, design, content, and/or configuration of one or more websites 104a-104n. In particular, a user may access and modify (via one or more appropriate graphical elements) module 300; template 302; flow-chart 304; web page lists 306; module configuration option 308; module assignment option 310; custom content option 312; upload option 314; welcome message 316; purchase option 318; payment option 320; data option 322; web page management option 324; web page updating option 326, miscellaneous option 328, and/or user sale module 330 (FIG. 3) via content management system 102a. Once modified, module 300; template 302; flow-chart 304; web page lists 306; module configuration option 308; module assignment option 310; custom content option 312; upload option 314; welcome message 316; purchase option 318; payment option 320; data option 322; web page management option 324; web page updating option 326, miscellaneous option 328, and/or user sale module 330 collectively comprise “module configuration information.” It will be understood therefore that module configuration information further relates at least to one or more website content elements (content module configuration information) and/or website design elements (design module configuration information), which of course may be modified via one or more appropriate graphical elements provided with respect to one or more content management systems 102a-102n. Moreover, in particular embodiments, “assigning” a module may comprise “toggling” on or off various features associated with one or more websites 104a-104n. The particular assignment options may vary according to particular needs, as well as according to various business considerations.

A user may store module configuration information (relating to content, design, or both) in an internal memory component of content management system 102a. In other particular embodiments, module configuration information may be stored directly or indirectly on a user's desktop, in a database, or in any other appropriate location in direct or indirect communication with content management system 102a. In addition to the foregoing, it will be understood that a user may likewise access and modify any other various options (via other appropriate graphical elements) of any suitable number of graphical elements, as may be provided in content management system 102a, according to particular needs.

In some particular embodiments, module configuration information may only be stored by a user after (or while) the user purchases a service or services, such as at via at least purchase option 318 and/or payment option 320 (notwithstanding that the user information and/or modifications may be reflected in websites 104a-104n in real-time). In those embodiments where a purchase is required before module configuration information is stored, purchase option 318 and/or payment option 320 (collectively, “checkout options”) may be provided only to a new user, or a user who is not recognized as having previously purchased the inventors' goods and/or services. Checkout options may comprise options relating to: services (premium design package, standard design package, etc.); payment (recurring, one time, etc.); and any other option relating to the purchase and checkout of one or more goods or services. Upon selecting one or more checkout options, module configuration information may be communicated from content management system 102a to database 108. In some particular embodiments, the communication of module configuration information may involve the module configuration information being “pulled” from content management system 102a by database 108. In addition, in particular embodiments, when a user selects one or more checkout options (via purchase option 318 and/or payment option 320), content management system 102a may direct the user to checkout system 110 (which, in particular embodiments, may comprise one or more payment screens). Also, in particular embodiments, checkout system 110 may comprise one or more “up-sell” modules, one or more “chat” modules, one or more “blog” modules, one or more real estate modules, one or more user sale modules 330, or any other module relating to any other functionality, content, or feature consistent with the scope of this disclosure. It will be understood that one or more users may sell goods and services to one or more other users via one or more user sale modules 330. In particular, it will be understood that users may be able to configure one or more user sale modules 330 in order to list products/services for sale in a format pleasing to that user. Therefore, in particular embodiments, all a particular user's shopping needs may be satisfied through the strategic location of one or more modules in a single checkout system 110.

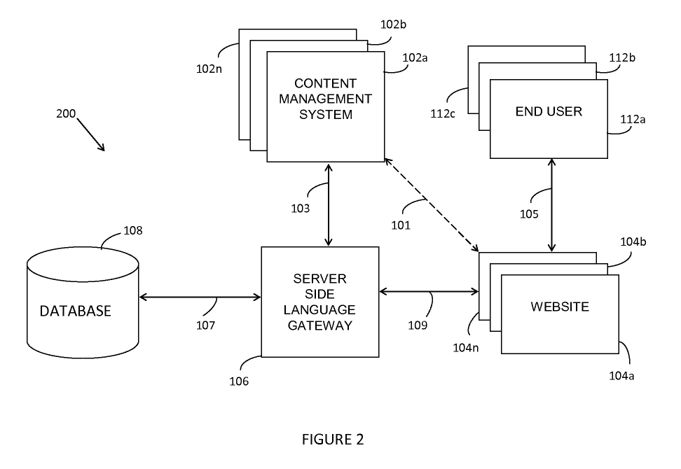

Referring specifically to FIG. 2 and to yet further explain the operation of one or more content management systems 102a-102n, another non-limiting example is now given. In one particular embodiment, content management system 102b may be provided to allow management of one or more websites 104a-104n. In this particular embodiment, content management system 102b comprises one or more graphical elements representing module 300, template 302, flow-chart 304,web page list 306, module configuration option 308, module assignment option 310, custom content option 312, upload option 314, purchase option 318, payment option 320, data option 322, web page management option 324, web page updating option 326, miscellaneous options 328 and/or user sale module 330. In some particular embodiments, content management system 102b may only be provided to a user after the user has purchased a particular product or service (or has otherwise selected one or more checkout options), such as via purchase option 318 and payment option 320 of content management system 102a, in particular embodiments. Therefore, in some particular embodiments, a user may manage the appearance and content of one or more websites 104a-104n via content management system 102b, especially in those instances where one or more websites 104a-104n have already been created.

Management of the appearance and/or content of one or more websites 104a-104n may be accomplished by a user selecting one or more of one or more graphical elements representing module 300, template 302, flow-chart 304,web page list 306, module configuration option 308, module assignment option 310, custom content option 312, upload option 314, purchase option 318, payment option 320, data option 322, web page management option 324, web page updating option 326, miscellaneous options 328 and/or user sale module 330.

A user wishing to manage or alter the appearance, content, organization and/or color theme of a website may do so by accessing one of module 300, template 302, flow-chart 304,web page list 306, module configuration option 308, module assignment option 310, custom content option 312, upload option 314, purchase option 318, payment option 320, data option 322, web page management option 324, web page updating option 326, miscellaneous options 328 and/or user sale module 330. In particular, a user desiring to manage, select, configure or assign new or different modules for one or more websites 104a-104n may do so via module 300, module configuration option 308, module assignment option 310, web page management option 322, web page updating option 324, and/or miscellaneous design option 328, respectively. Similarly, a user wishing to manage or select new or different templates for one or more websites 104a-104n may do so via template 302. Likewise, a user wishing to manage or alter the flow or organization of individual pages of one or more websites 104a-104n may do so via flow-chart 304, web page list 306, and/or miscellaneous design option 328. Furthermore, a user wishing to upload custom content (such as text, video, audio, movies, and other content) for one or more websites 104a-104n may access at least one of custom content option 312, upload option 314 and miscellaneous content option 330 in order to upload their content. In particular embodiments, custom content may comprise video capture that may be communicated, on the fly, directly to database 108. It will be understood that checkout system 110 is absent from FIG. 2 because, in particular embodiments, once a user has already selected one or more checkout options, that user may not be provided with welcome screen 316, and may not be directed to checkout system 110. Also, communication link 101 is shown in dashed lines because, in particular embodiments, communication link 101 may not be provided. In those embodiments where communications link 101 is not provided, it will be understood that module configuration information from one or more content management systems 102a-102n may not be reflected on the one or more websites 104a-104n in real time. In any event, with respect to any of the foregoing examples, module configuration information may be stored by a user either before or after selecting one or more checkout options.

To still further explain the operation of one or more content management systems 102a-102n, another non-limiting example is now given. In one particular embodiment, content management system 102c may be provided to allow updating of one or more websites 104a-104n. In this particular embodiment, content management system 102c comprises one or more graphical elements representing module 300, template 302, flow-chart 304,web page list 306, module configuration option 308, module assignment option 310, custom content option 312, upload option 314, purchase option 318, payment option 320, data option 322, web page management option 324, web page updating option 326, miscellaneous options 328 and/or user sale module 330. In particular, a user desiring to manage, select, configure or assign new or different modules for one or more websites 104a-104n may do so via module 300, module configuration option 308, module assignment option 310, web page management option 322, web page updating option 324, and/or miscellaneous design option 328. In some particular embodiments, content management system 102c may only be provided to a user after the user has purchased a particular product or service, such as via purchase option 318 and/or payment option 320 of content management system 102a, in particular embodiments. Accordingly, in some particular embodiments, a user may update the appearance and content of one or more websites 104a-104n via content management system 102c, especially in those instances where one or more websites 104a-104n have already been created.

Updating the appearance and/or content of one or more websites 104a-104n may be necessitated in many cases by business or personal eventualities, such as change of a contact address or telephone number, changes to products or prices, or any other changes that a user wishes to have reflected in one or more updates to one or more websites 104a-104n. Updates to one or more websites 104a-104n may be accomplished by a user selecting one or more of one or more graphical elements representing module 300, template 302, flow-chart 304,web page list 306, module configuration option 308, module assignment option 310, custom content option 312, upload option 314, purchase option 318, payment option 320, data option 322, web page management option 324, web page updating option 326, miscellaneous options 328 and/or user sale module 330. In particular, a user desiring to manage, select, configure or assign new or different modules for one or more websites 104a-104n may do so via module 300, module configuration option 308, module assignment option 310, web page management option 322, web page updating option 324, and/or miscellaneous design option 328. It will be understood that, in particular embodiments, a user may update one or more websites 104a-104n by first upgrading their pricing package (such as via purchase option 318 and/or payment option 320). Where a user has upgraded their pricing package, one or more website parameters of one or more websites 104a-104n may be concomitantly updated to reflect the new pricing package and to allow configurability of one or more websites 104a-104n consistent with the new pricing package.

Therefore, a user wishing to update or alter the appearance, content, organization and/or color theme of a website may do so by accessing one of module 300, template 302, flow-chart 304,web page list 306, module configuration option 308, module assignment option 310, custom content option 312, upload option 314, purchase option 318, payment option 320, data option 322, web page management option 324, web page updating option 326, miscellaneous options 328 and/or user sale module 330. Specifically, a user desiring to update, select, configure or assign new or different modules for one or more websites 104a-104n may do so via module 300, module configuration option 308, module assignment option 310, web page management option 322, web page updating option 324, and/or miscellaneous design option 328, respectively. Similarly, a user wishing to update or select new or different templates for one or more websites 104a-104n may do so via template 302. Likewise, a user wishing to update or alter the flow or organization of individual pages of one or more websites 104a-104n may do so at least via flow-chart 304 and/or web page list 306. Furthermore, a user wishing to update or upload custom content (such as text, video, audio, movies, and other content) for one or more websites 104a-104n may access one or more of custom content option 312,upload option 314, and miscellaneous content option 330 in order to upload their content. Notwithstanding, in particular embodiments, one or more websites 104a-104n may be configured to update automatically. In those embodiments where one or more websites 104a-104n are configured to update automatically, such updates may be located internally or externally with respect to the one or more websites 104a-104n.

While particular non-limiting examples of content management systems 102a, 102b, and 102c have been shown and described, it will be understood that many additional content management system possibilities may be provided for, consistent with the disclosures contained herein. In particular, it is specifically contemplated that content management system 102d may be provided. In some particular embodiments, content management system 102d may run on a user's desktop and may allow a user to “drag-and-drop” content to be reflected on one or more websites 104a-104n such as, by way of non-limiting example, using Adobe® Air® software. Many additional content management systems 102a-102n are possible, consistent with the disclosures contained herein. In some particular embodiments, one or more content management systems 102a-102n of two or more users may be linked to form a “community forum” in order to allow communication between the two or more users. Also, in particular embodiments, a global directory of all users may be provided, whereby one or more users may search out and communicate with another one or more users (which may comprise trusted and/or untrusted users).

With respect to any of the foregoing embodiments, one or more content management systems 102a-102n may receive from one or more websites 104a-104n an indication of which particular configuration and/or customization are allowed by the one or more websites 104a-104n. Accordingly, a user may only be allowed to change, configure, manage, upload and/or update one or more websites 104a-104n as allowed by one or more website parameters. Website parameters may include, by way of non-limiting example, elements such as the number of pages allowed on one or more websites 104a-104n, the size of files that may be associated with one or more websites 104a-104n, the color schemes that may displayed on one or more websites 104a-104n, or any other parameter relating to the functionality and/or ornamental appearance of one or more websites 104a-104n. Website parameters may depend upon many factors such as, by way of non-limiting example, the particular website pricing package that a user has purchased. As noted above, a variety of website design packages may be offered to users such as via purchase option 318 and/or payment option 320. In some particular embodiments, therefore, one or more website parameters may depend upon the type of package purchased by a user. By way of further non-limiting example, one or more websites 104a-104n created pursuant to a premium pricing package, therefore, may allow greater configurability, functionality and customizability than one or more websites 104a-104n created according to a basic pricing package. In any event, with respect to any of the foregoing embodiments, one or more content management systems 102a-102n may receive from one or more websites 104a-104n an indication of which particular configuration and/or customization are allowed by one or more website parameters associated with one or more websites 104a-104n.

As noted above, when a user makes changes to one or more content management systems 102a-102n (such as, by way of non-limiting example, by selecting templates, creating flow-charts, assigning modules, uploading, managing and/or updating), those changes may be reflected in one or more websites 104a-104n in real time. Specifically, a change to module 300, template 302, flow-chart 304,web page list 306, module configuration option 308, module assignment option 310, custom content option 312, upload option 314, purchase option 318, payment option 320, data option 320, web page management option 322, web page updating option 324, and/or via any other appropriate graphical element) may be instantaneously visually represented on one or more websites 104a-104n.

As noted above, upon a user selecting one or more checkout options (such as via purchase option 318 and/or payment option 320), user information and/or modifications may be communicated from one or more content management systems 102a-102n to database 108. In particular embodiments, user information and/or modifications may be communicated from one or more content management systems 102a-102n to database 108 via server side language gateway 106. In any event, in some particular embodiments, server side language gateway 106 is operable to receive module configuration information which, by way of non-limiting example, may comprise any information received from one or more content management systems 102a-102n. Module configuration information may comprise any programming or scripting language such as, by way of non-limiting example, PHP, JAVA, Perl, ASP, ASP.NET, and/or C++. In some particular embodiments, module configuration information may comprise any text based serialization language. Once module configuration information is received in server side language gateway 106, the module configuration information may be translated by server side language gateway 106. In some particular embodiments, translation of module configuration information may comprise server side language gateway 106 “pulling” the module configuration information from database 108 (which, in particular embodiments, is in communication with one or more content management systems 102a-102n via server side language gateway 106). In any event, once received in server side language gateway 106, module configuration information may be converted or translated from its specific programming or scripting language, to a readable format such as, by way of non-limiting example, XML, or another text-based serialization language. After translating module configuration information, server side language gateway 106 is operable to output (communicate) the translated module configuration information to one or more websites 104a-104n. Translated module configuration information may comprise translated content module configuration information and translated design module configuration information.

One or more websites 104a-104n are each operable to receive translated module configuration information from server side language gateway 106. After translated module configuration information has been received by one or more websites 104a-104n (which may occur in real time, in particular embodiments), the one or more websites 104a-104n are operable to configure the translated module configuration information to fit one or more websites parameters. Therefore, configuring translated module configuration information may comprise, by way of non-limiting example, configuring the translated module configuration information to conform with the number of web pages allowed on one or more websites 104a-104n. By way of further non-limiting example, configuring translated module configuration information may comprise configuring the translated module configuration information to conform with a file size limit, color scheme, template, page list, or any other parameter relating to the functionality and/or ornamental appearance of one or more websites 104a-104n. Once configured (which may occur in real time, in particular embodiments), one or more websites 104a-104n are operable to render a visual representation of the translated module configuration information. In some particular embodiments, rendering a visual representation of the translated module configuration information may comprise combining together translated content module configuration information and translated design module configuration information which may be stored in separate locations. In other particular embodiments, content module configuration information and design module configuration information may be located in the same location (or even the same module), and thus may not be required to be combined in order to be rendered. In yet other particular embodiments, one or more websites 104a-104n may render a visual representation of the translated module configuration information each time one or more end users 112a-112n opens or refreshes one or more websites 104a-104n, or one or more web pages thereof. In any event, one or more websites 104a-104n may render a visual representation either two-dimensionally (2-D) or three-dimensionally (3-D).

Notwithstanding, with respect to any of the foregoing embodiments, one or more end users 112a-112n may view and/or interact with one or more websites 104a-104n. In some particular embodiments, one or more end users 112a-112n may view one or more websites 104a-104n in real time. That is, one or more users 112a-112n may view changes made to one or more websites 104a-104n, as the changes are actually occurring. In other particular embodiments, one or more end users 112a-112n may not view changes to one or more websites 104a-104n in real time, particularly where translated content module configuration information and translated design module configuration information are stored separately and are merged when one or more end users 112a-112n attempt to view one or more websites 104a-104n.

In one embodiment, website design system 100 may operate on one or more computers, mobile telephones, PDA's and/or the like that may be integral to, or separate from, the hardware and/or software that support website design system 100, one or more content management systems 102a-102n, one or more websites 104a-104n, server side language gateway 106, database 108, cart 110, one or more end users 112a-112n, and communication links 101, 103, 105, 107, 109, and 111. These one or more computers, mobile telephones, PDA's and/or the like may include any suitable input device, such as a keypad, mouse, touch screen, microphone, or other device to input information. In addition, these one or more computers, mobile telephones, PDA's and the like may include any suitable output device that may convey information associated with the operation of website design system 100, including digital or analog data, visual information, or audio information. Furthermore, these one or more computers, mobile telephones, PDA's and the like may include fixed or removable computer storage media, such as magnetic computer disks, CD-ROM, or other suitable media to receive output from and provide input to website design system 100. In addition, these one or more computers may include one or more processors or processing units and associated memory to execute instructions and manipulate information according to the operation of website design system 100.

In addition, or as an alternative, website design system 100, one or more content management systems 102a-102n, one or more websites 104a-104n, server side language gateway 106, database 108, cart 110, and one or more end users 112a-112n may each operate on one or more separate computers or may operate on one or more shared computers (or mobile telephones, PDAs, and/or the like). Each of these one or more computers may be a work station, personal computer (PC), network computer, mobile telephone, personal digital assistant (PDA), wireless data port, or any other suitable computing device. In another embodiment, one or more users may be associated with one or more content management systems 102a-102n, one or more websites 104a-104n, server side language gateway 106, database 108, cart 110, and one or more end users 112a-112n. These one or more users may include, for example, a “customer” creating a custom website and/or one or more related tasks within website design system 100. In addition, or as an alternative, these one or more users within website design system 100may include, for example, one or more computers programmed to autonomously handle website design and/or one or more related tasks within website design system 100.

In one embodiment, website design system 100 may be coupled with a network via an appropriate communications link, which may be any wireline, wireless, or other link suitable to support data communications between website design system 100 and a network during operation of website design system 100. One or more users may be coupled with the network via an appropriate communications link,

Although communication links 101, 103, 105, 107, 109, 111 and other appropriate communication links are described as generally coupling Although communication links 101, 103, 105, 107, 109, 111 and other appropriate communication links are described as generally coupling one or more content management systems 102a-102n, one or more websites 104a-104n, server side language gateway 106, database 108, cart 110, and one or more end users 112a-112n, the foregoing may communicate directly with each other, according to particular needs. In addition, or as an alternative, website design system 100 may reside within one or more websites 104a-104n, according to particular needs.

In another embodiment, website design system 100 may include the Internet and any appropriate local area networks (LANs), metropolitan area networks (MANS), or wide area networks (WANs) coupling one or more content management systems 102a-102n, one or more websites 104a-104n, server side language gateway 106, database 108, cart 110, and one or more end users 112a-112n. Those skilled in the art will recognize that the complete structure and operation of website design system 100 and implementing components are not depicted or described. Embodiments may be employed in conjunction with known communications networks, structures, and other components. In addition to the foregoing, there are a variety of method and software which are described below.

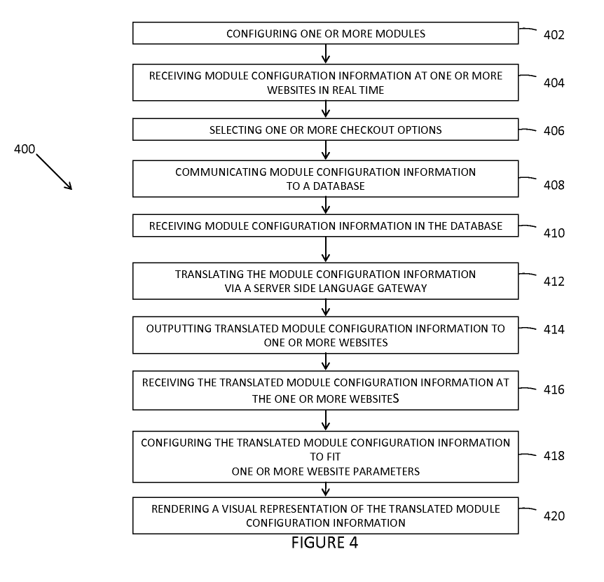

FIG. 4 illustrates an exemplary method 400 for creating one or more custom websites using the inventors' method for website design. The method begins at step 402, a user may configure one or more modules. As discussed above, configuration of one or more modules may comprise configuring information relating to both website content and website design. At step 404, the module configuration information from step 402 is received at one or more websites in real time. As described above, module configuration information from step 402 is received by, and may be instantaneously visually represented, on one or more websites 104a-104n. At step 406, a user may select one or more checkout options. As described above, selecting one or more checkout options may be performed at least via purchase option 318 and/or payment option 320. Nevertheless, in some particular embodiments, if a user does not select one or more checkout options, then the method may end before step 406 is completed. Notwithstanding, in some particular embodiments, if a user selects one or more checkout options, the method proceeds to step 408. At step 408, module configuration information is communicated to a database. As described above, if one or more content management systems 102a-102n determine that a user has selected one or more checkout options (at step 406), module configuration information may be communicated to database 108 and the user may be directed to checkout system 110 (which may occur either before or after module configuration information is stored in database 108).

At step 410, because module configuration information is communicated to a database, database 108 receives the module configuration information. At step 412, the module configuration information is translated via a server side language gateway. As described above, translation comprises translating module configuration information from its specific programming or scripting language, to a readable format such as, by way of non-limiting example, XML, or another text-based serialization language. At step 414, translated module configuration information is outputted from server side language gateway 106 to one or more websites 104a-104n such as, by way of non-limiting example, via communication link 109. At step 416, one or more websites 104a-104n receive the translated module configuration information from server side language gateway 106. At step 418, the translated module configuration information is configured by one or more websites 104a-104n to fit one or more website parameters. As described above, one or more websites 104a-104n may comprise one or more website parameters relating to the functionality and/or appearance of the one or more websites 104a-104n.

At step 420, a visual representation of the translated module configuration information is rendered. As described above, rendering a visual representation of the translated module configuration information may comprise combining together translated content module configuration information and translated design module configuration information. Also, as further described above, in particular embodiments, one or more websites 104a-104n may render a visual representation of the translated module configuration information each time one or more end users 112a-112n opens or refreshes a website or one or more pages of one or more websites 104a-104n. Although FIG. 4 illustrates one particular embodiment of a computer-implemented method for website design, various changes may be made to method 400 without departing from the scope of embodiments described herein.

While the exemplary embodiments have been shown and described, it will be understood that various changes and modifications to the foregoing embodiments and/or embodiments may become apparent to those skilled in the art without departing from the spirit and scope of the present descriptions.

What is claimed is:

1. A system for website design comprising a content management system having a storage medium stored therein, wherein:
the content management system is configured to configure one or more modules; and
one or more websites comprise a storage medium stored therein and one or more web pages, the one or more websites in communication with the content management system and configured to receive real time module configuration information from the content management system and render a visual representation of the module configuration information.

2. The system of claim 1, wherein the content management system comprises one or more checkout options.

3. The system of claim 1, wherein the module configuration information is received in a database configured to receive and store module configuration information.

4. The system of claim 3, wherein the module configuration information is received in the database in response to a user computer selecting one of the one or more checkout options.

5. The system of claim 3, wherein the module configuration information is received in the database via a server side language gateway, the server side language gateway configured to:
receive the module configuration information from the content management system;
translate the module configuration information; and
output the translated module configuration information to the one or more websites.

6. The system of claim 5, wherein the translated module configuration information comprises a text based serialization language.

7. The system of claim 6, wherein the one or more websites are further configured to:
receive the translated module configuration information from the server side language gateway;
configure the translated module configuration information to fit one or more website parameters; and
render a visual representation of the translated module configuration information.

8. A computer-implemented method for website design, the method performed using a computer system comprising one or more processing units and one or more memory units, the method comprising:
configuring by a content management system one or more modules;
receiving in real time at one or more websites comprising a storage medium stored therein module configuration information;
communicating to a database module configuration information;
receiving in the database module configuration information;
translating by a server side language gateway the module configuration information;
outputting to the one or more websites translated module configuration information;
receiving at the one or more websites the translated module configuration information;
configuring by the one or more websites the translated module configuration information to fit one or more website parameters; and
rendering by the one or more websites a visual representation of the translated module configuration information.

9. The method of claim 8, wherein configuring one or more modules comprises selecting one or more templates.

10. The method of claim 8, wherein configuring one or more modules comprises creating a page map for one or more associated web pages for the one or more websites.

11. The method of claim 8, wherein configuring one or more modules comprises assigning one or more modules for at least one of the one or more associated web pages.

12. The method of claim 8, wherein communicating module configuration information to a database occurs in response to a user computer selecting one or more checkout options.

13. The method of claim 8, wherein configuring one or more modules comprises uploading custom content.

14. The method of claim 13, wherein uploading custom content occurs in response to a user computer selecting one or more checkout options.

15. The method of claim 13, wherein custom content comprises at least two of: text content; audio content; video content; software content; pictorial content; stylized content; and photographic content.

16. A computer readable storage medium storing software for website design, the software comprising a plurality of instructions and, when executed, operable to:
configure one or more modules via a content management system;
store module configuration information in the content management system; and
update in real time one or more websites in communication with the content management system with the module configuration information.

17. The software of claim 16, wherein the software is further configured to configure a database to receive the module configuration information from the content management system in response to a user computer selecting at least one of one or more checkout options.

18. The software of claim 17, wherein the software is further configured to provide one or more module configuration options based at least in response to a user computer selecting at least one of the one or more checkout options.

19. The software of claim 17, wherein the software is further operable to configure the content management system to provide a checkout system in response to a user computer selecting one of the one or more checkout options.

20. The software of claim 17, wherein the software is further operable to:
configure a server side language gateway to:
receive the module configuration information from the content management system;
translate the module configuration information; and
output the translated module configuration information from the server side language gateway to the one or more websites.

21. The software of claim 20, wherein at least one of receiving, translating and outputting the module configuration information occurs in real time.

22. The software of claim 20, wherein the software is further operable to configure the one or more websites to:
receive the translated module configuration information from the server side language gateway;
configure the translated module configuration information to fit one or more website parameters; and
render a visual representation of the translated module configuration information.

23. The software of claim 20, wherein at least one of receiving, configuring and rendering the translated module configuration information occurs in real time
